(19) United States
(12) Patent Application Publication
(10) Pub. No.: US 2016/0027323 A1
(43) Pub. Date: Jan. 28, 2016

(54) CHILD DEVELOPMENT PLATFORM

(71) Applicant: Lyfeline, Inc., San Mateo, CA (US)

(72) Inventors: Conlan MA, San Mateo, CA (US); Thanh Tran, San Jose, CA (US)

(21) Appl. No.: 14/811,619

(22) Filed: Jul. 28, 2015

Related U.S. Application Data
(60) Provisional application No. 62/030,016, filed on Jul. 28, 2014.

(51) Int. Cl. G09B 19/00; G09B 5/02; G09B 7/00

(52) U.S. Cl. CPC G09B 19/00; G09B 7/00; G09B 5/02

(57) ABSTRACT

Methods and systems are disclosed for a child development platform that helps parents understand, track, and improve their child's development, in some embodiments using principles related to game mechanics. According to one embodiment, a user may access the services of the platform via an application on a network-connected device. Available services include a game implementing a core loop for facilitating child development. The core loop may include receiving various cards such as challenge cards, information, cards and assessment cards and completing tasks associated with the received cards. Results may be continuously gathered and presented to parents to better inform and facilitate their child's development.

### CROSS-REFERENCE TO RELATED APPLICATION(S)

This application is entitled to the benefit of and/or the right of priority to U.S. Provisional Application No. 62/030,016, titled, “METHODS AND SYSTEMS FOR A CHILD DEVELOPMENT PLATFORM” (Attorney Docket No. 112085-8001.US00), filed Jul. 28, 2014, which is hereby incorporated by reference in its entirety for all purposes. This application is therefore entitled to a priority date of Jul. 28, 2014.

### BACKGROUND

Parents generally want to encourage and facilitate their child's growth and success, however a significant knowledge gap exists between what parents know and what they want to know in order to aid in their child's development. This is particularly true for new parents. Much information is currently available to assist parents, however this information must be actively sought (e.g., from books, websites, doctors, etc). This is can be ineffectual because parents often do not know what information to seek, how to use the information that is gathered, and information that is gathered is not necessarily tailored to the specific needs of their child.

### BRIEF DESCRIPTION OF THE DRAWINGS

The present embodiments are illustrated by way of example and are not intended to be limited by the figures of the accompanying drawings. In the drawings:

FIG. 1 is a diagram of an example system for providing the functionalities associated with a child development platform;

FIG. 2. is a high-level conceptual diagram of an example architecture for a child development platform;

FIGS. 3A-3F illustrate example user interfaces for a child development platform, accessible via a network-connected device;

FIG. 4 is a high-level flow chart illustrating an example “core-loop” process, implemented as part of the gamification model;

FIG. 5 is a schematic block diagram of an example cloud-based server capable of implementing a child development platform; and

FIG. 6 is a schematic block diagram of an example computing device for accessing services provided via the child development platform.

### DETAILED DESCRIPTION

From the foregoing, it will be appreciated that specific embodiments of the invention have been described herein for purposes of illustration, but that various modifications may be made without deviating from the scope of the invention. Accordingly, the invention is not limited except as by the appended claims.

### Overview

The present disclosure contemplates a variety of systems and methods for enabling a computer-implemented child development platform which helps parents to understand, track and improve their child's development using principles of game mechanics. According to some embodiments, users (in some cases parents) may access the functionalities described herein via a multi-function computing device (“device”) such as a smart phone, tablet device, or personal computer.

The mechanics of the systems and methods disclosed herein may be based around several fundamental assumptions, including: (i) that parents are intrinsically interesting in the development of their child, (ii) that parents want to understand how the development of their child compares to other children in similar age groups, and (iii) that parents want to promote the development areas of interest and address areas of concern.

Through principles of game mechanics, parents are incentivized to progress the development of their child through completing tasks with their children (e.g. challenges and assessments) and receiving points or other incentives based on the completion of the tasks. According to some embodiments, the child development platform may present a new child development paradigm in which parents and their children play a story-based game in which the child is the main character. The objective of the game may be to progress the child's development age (described herein) and push it ahead of the actual age of the child. By performing tasks, for example completing challenges or taking periodic assessments, parents and their children may receive incentives, for example, prizes, trophies, premium content, and/or experience points to progress to a next level or child development age.

According to some embodiments, the game or process may begin by parents performing an initial assessment of their child via the child development platform. For example, a standard question-based assessment tool such as the Ages & Stages Questionnaire (ASQ™) may be presented to the parents via a device (e.g. a smartphone) to identify the child's development ages and stage and in particular identify developmental areas of concern. Other suitable child development assessment tools may include, but are not limited to, the Child Development and Inventories (CDI), the Kent Inventory of Development Skills (KIDS), and the Parents' Evaluations of Development Status (PEDS). In response to the answers given, the child development platform may provide an initial assessment which may both provide insight to the parents as well as guide the presentation of the game or process.

According to some embodiments, once an initial assessment has been performed, the game or process may enter what is referred to as a “core loop.” During the core loop, parents may receive “cards” intermittently via a device. According to some embodiments, cards may come in different varieties including, challenge cards, information cards, and assessment cards. Parents may have the option of accepting the cards (i.e. by reading, taking the challenge, or performing the assessment). By completing cards, parents and their children may progress through the game or process and accumulate incentives such as experience points, prizes, awards, premium content etc.

In addition to guiding parents through the development of their child using principles of game mechanics, the systems and methods disclosed herein may also provide insights and experiences through the use of a rich semantic-based model of child development. According to some embodiments the child development may be quantified as series of developmental ages and stages determined based on gathered information (e.g, responses to assessment questionnaires) and user interactions with associated systems. Quantified information associated with a child's development (e.g., a developmental age) may be semantically presented to users in a distilled fashion in terms of milestones and topics captured by informational ontologies, for example via a Child Development Profile (CDP). According to some embodiments, analytics engines may automatically extract and derive developmental insights based on gathered information and interactions. For example, according to some embodiments, a CDP may provide users with a dashboard with information regarding their child's development age or status, or may provide a continuously updated timeline-based “journal” chronicling the child's development progress. Moments or experiences may be captured as images, video and/or audio (e.g. via a device) during the completion of challenges, assessments and other activities and may be presented to the parents via a “journal” which the parents can in turn share with others. Further, semantic-based recommendation engines may leverage information gathered using rich semantic representation models and semantic matchmaking algorithms to better tailor each user's experience of the “core loop” game process and effectively connect each user with relevant products and services according to their particular needs.

According to some embodiments, information associated with users 102a-102n and their children may be appropriately segregated and compartmentalized in its collection, storage use, and disclosure such that the systems and methods according to the present teachings comply with applicable data privacy regulations, particularly regulations associated with medical records such as privacy rules of the Health Insurance Portability and Accountability Act (HIPPA) and data privacy regulations such as the Children's Online Privacy Protection Act (COPPA), to name a few.

### A System for Providing a Child Development Platform

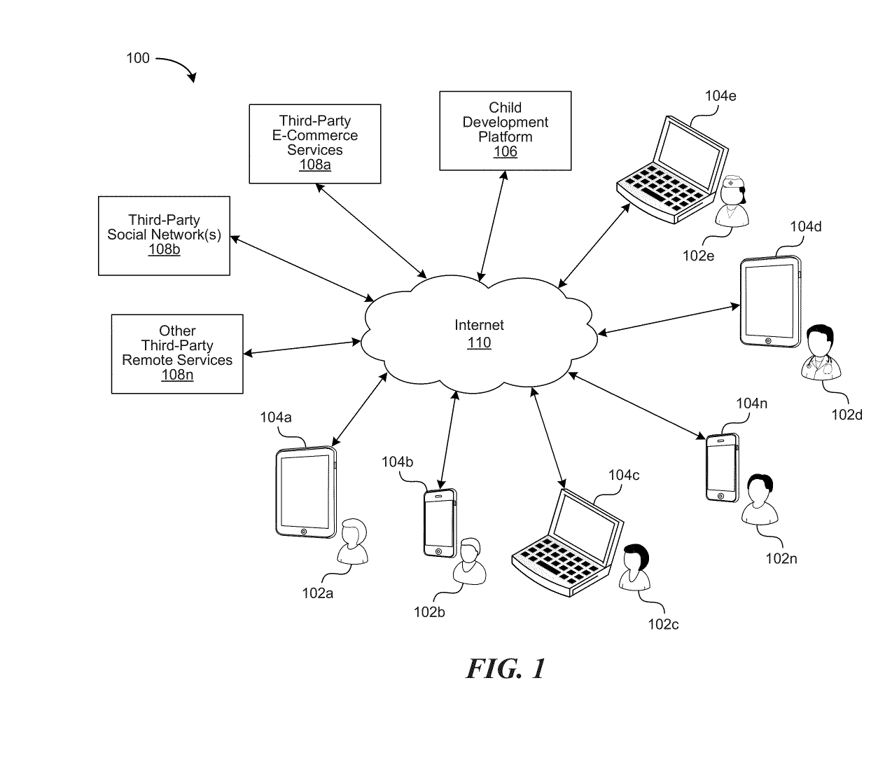

FIG. 1 is a diagram of an example system 100 for providing the functionalities associated with a child development platform according to some embodiments. As shown in FIG. 1, the system 100 may include multiple users 102a-102n using devices 104a-104n connected to a network 110. As mentioned earlier, users 102a-102n may be parents with young children, however users 102a-102n may also be friends and relatives of parents as well as experts in child development such as physicians, psychiatrists, psychologists, educators, counselors, therapists, etc. Devices 104a-104n may include, but are not limited to, smart glass devices (e.g., Google Glass®), smart phone devices (e.g. iPhone®, ANDROID® smart phones), tablet devices (e.g., iPad®, ANDROID® tablets), personal computers (including desktop, laptop and netbook computers), smart head up display devices, smart wearable devices, or any other devices capable of mobile computing. Additional details regarding devices, such as devices 104a-104n, are provided herein under the section titled, “Background on Computing Devices.” According to some embodiments, devices 104a-104n may include client software (e.g. an app) configured to provide users 102a-102n access to functionalities provided by Child Development Platform (“Platform”) 106. According to some embodiments, users 102a-102n may access Platform 106 without specific client software, for example via a web interface.

As mentioned, system 100 may include a Child Development Platform such as Platform 106 connected to network 110. Platform 106 may be implemented via a cloud-based server or distribution of servers that in conjunction with devices 104a-104n and remote services 108a-n facilitate the methods and systems described herein. Additional information on Platform 106 implemented as a cloud-based server(s), according to some embodiments, may be found in the section titled, “Background on Cloud-Based Servers.”

As mentioned, system 100 may also include one or more remote services 108a-108n, such as one or more third-party e-commerce services 108a, one or more third-party social network platforms 108b, all of which may be connected to network 110. According to some embodiments, remote services 108a-108n may provide additional functionality to user via Platform 106. For example, as will be described in more detail herein, a system in accordance with the present teachings may gain insights though user interactions and use these insights to recommend products or services that may be relevant to a the needs of particular users. Users may view these recommendations and may be provided with options to purchase products and services relevant to their child's development. According to some embodiments, products may include, but are not limited to toys, books, software, arts and crafts supplies, childcare accessories (e.g., strollers, bottles, clothing, carriages, etc.), educational tools and supplies (e.g. pencils, pens, notebooks, etc.), tools to complete challenges, or any other items that may assist in the development of the child. According to some embodiments, services may include, but are not limited to, advice from specialists and experts, educational classes, organized group activities, or any other services that may assist in the development of the child. Such products may be purchased directly via Platform 106 or may be purchased from third party vendors via third party e-commerce services 108a. As another example, as will be described in more detail herein, users may share completed challenges and child development progress with others. Such information may be shared with other users 102a-102n of Platform 106 directly through Platform 106, or may be shared with people not currently using Platform 106 via one or more third-party social network platforms 108b, for example, Facebook®, Instagram®, Twitter®, etc.

All of the aforementioned devices, including devices 104a-104n and any other computing devices associated with Platform 106 and remote services 108a-108n, may be connected to each other through one or more wired and/or wireless networks, for example network 110. In general, network 110 may include a cellular network, a telephonic network, an open network, such as the Internet, or a private network, such as an intranet and/or the extranet, or any combination or variation thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

Network 110 may be any collection of distinct networks operating wholly or partially in conjunction to provide connectivity to the devices 104a-104n, Platform 106 and remote services 108a-108n and may appear as one or more networks to the serviced systems and devices. In one embodiment, communications to and from the devices 104a-104n may be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), or any broadband network, and further enabled with technologies such as, by way of example, Global System for Mobile Communications (GSM), Personal Communications Service (PCS), Bluetooth, WiFi, Fixed Wireless Data, 2G, 2.5G, 3G (e.g., WCDMA/UMTS based 3G networks), 4G, IMT-Advanced, pre-4G, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, HSPA+, UMTS-TDD, 1×RTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks, broadband networks, or messaging protocols.

### Architecture—Overview

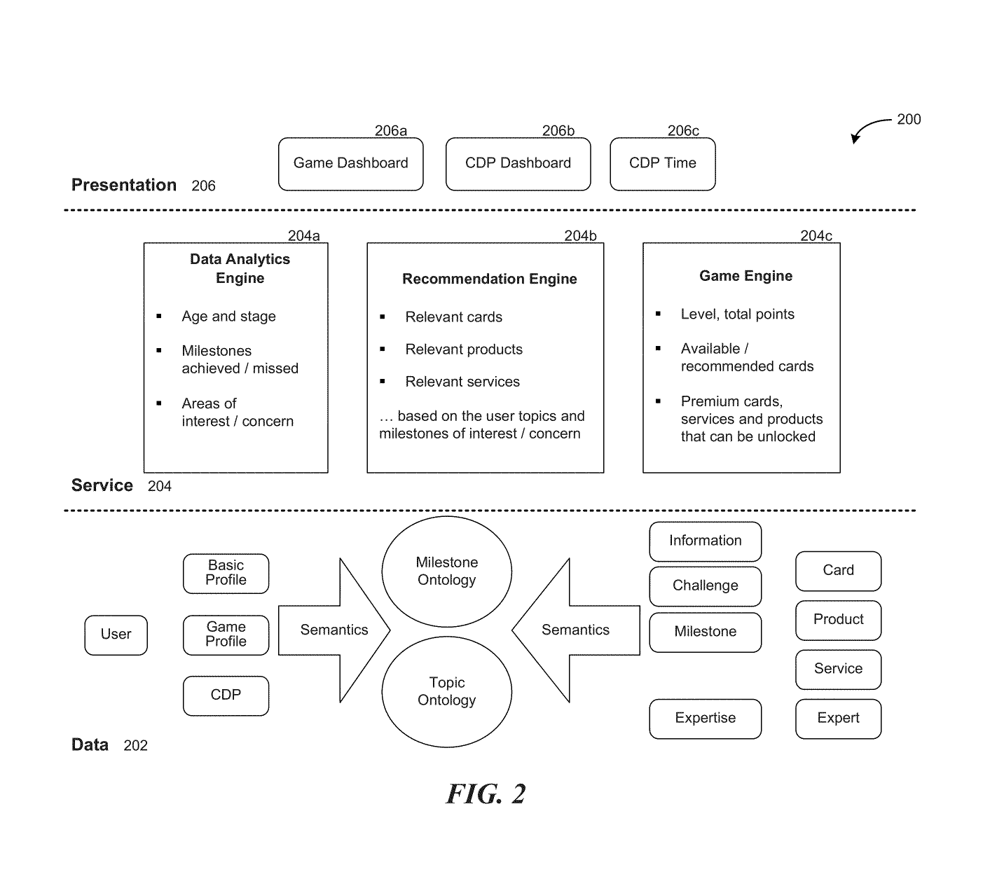

FIG. 2. is a high-level conceptual diagram of an example architecture 200 for implementing the techniques disclosed herein. According to some embodiments, architecture 200 may include a data layer 202, a service layer 204, and a presentation layer 206. For example, data layer 202 may define the way in which information is organized and interrelated as a basis of knowledge through one or more ontologies. The services layer 204 may include one or more services (e.g. data analytics engine 204a, recommendation engine 204b, and a journal and game engine 204c) that are configured to derive particular insights form collected information residing on the data layer. The presentation layer 206, may include one or more interfaces (e.g., game dashboard 206a, child development profile (CDP) 206b, and CDP timeline 206c) through which insights derived at the services layer 204 are presented to users (e.g. users 102a-102n).

### Architecture—Data Layer

As mentioned earlier, and with further reference to FIG. 2., the data layer may be understood as defining the way in which information collected and otherwise available is organized and interrelated as a basis of knowledge in various domains related to child development through the use of one or more ontologies.

Generally, an ontology is a formal representation of a set of knowledge as a hierarchy of concepts within a domain that use shared semantics to denote the types, properties and interrelationships between concepts. Ontologies may have various components including objects that represent instances of information within a domain and classes which represent sets of related objects. Objects and classes may have certain attributes or properties including associated taxonomies and may be interrelated based on the associated attributes or properties. According to some embodiments, a system according to the present teachings may employ two ontologies in a semi-automatic fashion capturing, 1) milestones, and 2) child developmental topics, herein referred to as a Milestone Ontology and a Topic Ontology.

According to some embodiments, data layer 202 may include information associated with various core domain objects 202a-202n including, but not limited to milestones, information topics, information cards, challenge cards, milestone cards, assessment cards, products, services, users, and expert users. Objects may be represented based on semantics. In other words, such as those just listed, may be captured in terms of specific topics and milestones. By knowing the topics and milestones the object refers to, systems and methods, according to the present teachings, may provide semantic recommendations. For example, if child misses a particular milestone such as being able to reach for or grasp a toy with both hands, a system (e.g. system 100) may recommend a particular challenge card (e.g., a “catch the roller” card) which is related to the “fine motor” skills topic and supports development towards this particular milestone. According to some embodiments, semantic representation may be a core enabler of a semantic recommendation engines.

According to some embodiments, a Milestone, as a core domain object, may represent an achievement in a particular child development category. For example, “speak first sentence,” may be a particular milestone object in a class of Milestone objects related to communication. Milestones and their relationships may be captured in a Milestone Ontology, such as described herein.

According to some embodiments, an Information topic, as a core domain object, may represent a particular topic related to child development. For example, according to some embodiments, information topics may mirror the child development topics identified in an assessment questionnaire (e.g., the ASQ™ 3), namely: (i) gross motor, (ii) fine motor, (iii) problem solving, (iv) personal social, and (v) communication. However, it is conceivable that other embodiments may organize a topic structure differently. Further, high-level information topics such as those just listed may be deconstructed into more fine-grained topics. For example, the “gross motor” topic may be deconstructed into finer topics such as “crawling,” “standing,” “walking,” “running,” etc. Information topics and their relationships may be captured in a Topic Ontology, such as described herein.

According to some embodiments, cards associated with the “core loop” game mechanic may be represented as core domain objects.

An information/quiz card may present to the user a short article about one or more child development topics with the aim of providing insight for the parent in those areas. Information cards may be related to topics based on the Topic Ontology or to milestones based on the Milestone Ontology. For example, if a child's development in a certain topic (say, fine motor) is lagging, the recommendation engine (described in more detail herein) may push information cards in that topic area for the parents to read so that child's development may be more effectively nurtured. This card may also present information in the form of a quiz with the aim or providing insight in a more interactive way where users may learn from selecting answers to a set of questions.

Similarly a challenge card may present a description of a particular exercise, activity or game to be performed by the child with the aim of developing in a particular topic towards a particular milestone. For example, consider a “catch the roller” challenge card. The “catch the roller” challenge car may include a number of attributes. According to some embodiments, the challenge car may include a core objective, namely to encourage an activity that will help a baby to develop balance and motor control of his or her trunk and limbs while encouraging the baby's curiosity in exploring his or her environment. The challenge card may be related to a particular Information topic, namely “fine motor.” The challenge card may be related to one or more particular milestones, for example, “baby can reach for or grasp a toy using both hands at once,” or “baby can grab or scratch his fingers on a surface in front of him, either while being held in a sitting position or when he is on his tummy.” The challenge card may be related to particular materials or products, for example, a musical roller. Finally, the challenge card may be related to a set of procedures or activities. For example, the procedures may include: (i) placing the baby on his or her belly on the floor; (ii) placing the musical roller in front of the baby; (iii) encouraging the baby to reach for the musical roller; (iv) when the toy rolls away from the baby, gently rolling it back toward the baby; (v) repeating several times or as long as the baby wants to play; and (vi) allowing the baby to explore the musical roller by holding it still for a few moments.

A milestone card may capture a particular milestone via textual description, images, video and/or audio. According to some embodiments, if a challenge card targets a milestone directly, the milestone card may be directly associated with that challenge.

An assessment card may present one or more questions to the parent. For example, questions such as those included in an assessment questionnaire (e.g., the ASQ™ 3). Responses by the parent to these questions may represent milestones achieved or not achieved. An example question on an assessment card related to the fine motor topic may be, “dies your baby hold his or her hands open or partly open rather than as fists as they may have done as a newborn?”

According to some embodiments, products and services related to topics and milestones may be represented as core domain objects. For example, recall the “catch the roller” challenge card previously discussed. A product associated with this challenge card in particular or the “fine motor” topic in general may be the musical roller used to perform the challenge, or a ball or other toy that may assist promote development in the fine motor topic.

According to some embodiments, users may be represented as core domain objects. For example, parents may have a user profile with associated information, their children may have a child development profile (“CDP”) with associated information based on an initial assessment as well as subsequent challenges and assessments performed during the “core loop.” The information in the CDP may span the various child development topics. Similarly, experts as users, may have general information, such as qualifications, affiliation, expertise, etc. Expertise may be described in terms of Information topics (see Topic Ontology) and milestones (see Milestone Ontology). For example trouble encountered achieving a particular milestone may trigger input or consultation from a particular expert or set of experts associated with that milestone. Expertise may be manually input by the experts themselves or automatically derived from available information, for example from the questions answered and coaching services provided by the experts.

A Topic Ontology may be constructed based on existing taxonomies and or dictionaries related to child development. In this regard, the Topic Ontology would formalize and capture the terminological knowledge about child developmental. In other words, it would capture child development topics and their semantic relationships. It will be understood that a Topic Ontology may be static, i.e. based on the current knowledge around child development and perhaps manually updated periodically to reflect changes, or a Topic Ontology may be dynamic, continuously reorganizing semantic relationships based on information gathered, e.g. from parent users or expert users. The Topic Ontology may be used to semantically annotate and describe various core domain objects, for example, information cards as well as expertise.

A Milestone Ontology may be constructed manually based on prevailing expert opinions. In this regard, the Milestone Ontology would formalize and capture the terminological knowledge about child development achievements (milestones) and their relationships, both temporal and causal. It will be understood that a Milestone Ontology may be static, i.e. based on the current knowledge around child development milestones and perhaps manually updated periodically to reflect changes, or a Milestone Ontology may be dynamic, continuously reorganizing semantic relationships based on information gathered, e.g. from parent users or expert users.

The Milestone Ontology may be used to semantically annotate and describe various core domain objects, for example, challenge/assessment/information cards as well as products, services and expertise.

### Architecture—Services Layer

With reference to FIG. 2, the services layer 204 may include one or more services (e.g. data analytics engine 204a, recommendation engine 204b, and game engine 204c) that are configured to derive particular insights form collected information residing on the data layer. Services may be provided by a system, for example system 100 in FIG. 1. According to some embodiments, service engines (e.g. data analytics engine 204a, recommendation engine 204b, and game engine 204c) may be implemented using computer software, hardware or combinations of both. According to some embodiments, one or more service engines may be instantiated on cloud-based servers associated with Platform 106 or on the one or more devices 104a-104n, or any combination thereof.

A key component of the services layer is a data collection component (not represented in FIG. 2). As part of a the data collection component, a system 100 according to the present teachings, may collect various types of information, including, but not limited to, basic user information (e.g. usernames and passwords), basic information about the child (e.g., sex and date of birth), and information regarding relevant interactions between users and systems. Information on relevant interactions between users and system may include, but are not limited to, cards accessed by users, responses to assessment cards (e.g., yes/no responses to assessment questionnaires, or written responses to milestones or overall development related questions), responses to challenge cards (e.g., yes/no results to exercises that aim at specific milestones), and information provided by users for milestone validation (e.g. by posting a video of a child performing a milestone challenge for validation by an expert). Data may also be collected through the sharing of achievements at various levels (e.g. through sharing of the CDP) with friends, family members, and caretakers. Data may also be collected through user response to product and service recommendations.

One or more data analytics engines 204a may be used to derive insights form all of the data captured as part of the data collection component.

According to some embodiments, insights may be derived for parents with information useful for them to understand the developmental age and stages of children. For example, information that may be derived may include, but is not limited to: (i) a score based on responses to assessment questions (e.g., an ASQ score); (ii) a developmental age/stage corresponding to the assessment score; and (iii) a relative developmental age/stage score relating the development of one child to the scores achieved by other children of a similar age in similar circumstances, or averaged nationally. Such insights may be used at presentation layer, for example by dashboard 206a, child development profile (CDP) 206b, and CDP timeline 206c.

According to some embodiments, insights may be derived for experts who may use the information to identify problem areas, suggest remedies and analyze results. For example, information that may be derived for experts may include, but is not limited to: (i) specific assessment questionnaire responses (e.g. which milestones were not achieved?); (ii) statistical significance of these under-achievements (e.g., impact these deficiencies these may have in other developmental areas); and (iii) exercises/treatments attempted to address concerns as well as their associated results (recordings). Such insights may be used at the presentation layer, for example by an embodiment of a CDP 206b shared by parents with an expert.

According to some embodiments, insights may also be derived to inform a child development platform, e.g. Platform 106, and improve its effectiveness and utility to users. For example, information that may be derived for Platform 106 may include, but is not limited to: (i) development age/stage for each child associated with users 102a-102n; (ii) specific areas of interest to users 102a-102n (e.g., based on information read, challenges attempted, achievements recorded and shared—these may be represented in terms of topics and milestones, i.e. what are the information topics and milestones that a particular user is interested in?), and (iii) specific areas of concern for users 102a-102n (e.g., based on challenges failed and under-achievements as reflected in the assessment results). Such insights may be used by recommendation engines, for example recommendation engine 204b.

According to some embodiments, one or more recommendation engines 204b may utilize an ontology-based approach to recommendations. In other words, recommendation engines 204b may use explicit semantics captured via ontologies to derive recommendations that are semantically meaningful. As described earlier with regard to the data layer, various core domain objects (e.g., users, profiles, cards, products, services, etc.) may be semantically represented as topics and milestones and may be related based on Topic and Milestone Ontologies.

Recommendations may therefore be implemented via semantic matchmaking algorithms (e.g., S-Match).

A recommendation engine 204b may provide game recommendations by semantic matchmaking of a particular user with a particular card. For example, a parent may answer questions about their child as part of an initial assessment. A data analytics engine 204a may process the input data and provide insights to recommendation engine 204b, which may then match specific cards to meet the needs of the child based on the previously described ontologies. A recommendation engine 204b may also provide service recommendations by semantic matchmaking of a particular user with a particular service. For example, based on insights provided by a data analytics engine 204a based on responses by a parent to an initial assessment, a recommendation engine 204 may recommend a particular service (e.g. speech therapy) to meet the specific needs of the child.

A recommendation engine 204b may also provide product recommendations by semantic matchmaking of a particular user with a particular product. For example, based on insights provided by a data analytics engine 204a based on a parent reading about problem solving exercises on an information card, a recommendation engine may provide recommendations for certain products (for example toys or puzzles intended to promote development problem-solving skills). According to some embodiments, recommendations from recommendation engine 204b may be provided to users with links to purchase those products from third-party vendors, for example third-party e-commerce services 108b. Further product and service recommendations may also come from insights into child or parent's background, location, online behavior, etc. For example, based on information provided in a user profile, a data analytics engine 204a may provide insights suggesting that a particular user is located in a particular region and has higher-end spending habits. Accordingly, a recommendation engine may recommend a more expensive toy from a boutique toy maker located in close proximity to the user.

According to some embodiments, recommendation engine 204b may derive recommendations based on interest/concern-based semantic matchmaking. Where a user's interests and concerns can be represented according to the topic/milestone ontology, recommendations for cards, services, and products can be made that address related topics and milestones. For example, knowing the a child missed the “baby reach for or grasp a toy using both hands at once” milestone, recommendation engine 204b may recommend the “Catch the roller” challenge, which is about “fine motor” (topic) and supports this particular milestone.

According to some embodiments, a game engine 204c may define the framework responsible for the mechanics of a “core loop” gamification model for child development. The “core loop” gamification model is described in more detail under the section, titled “The ‘Core Loop’ Gamification Model.”

Briefly, game engine 204c may collect and process data associated with every user. For example, the game engine 204c may collect, (i) a current level, (ii) total points, (iv) activities and the points rewarded, (v) cards unlocked, (vi) awards/badges/trophies received, and (vii) cards and other rewards that can be purchased with points. According to some embodiments, user activities may be designed as part of a game where the goal is to obtain points that help to advance to the next level. Activities may be mainly captured through the use of cards, including but not limited to, information cards, challenge cars, and assessment cards. Points may be awarded for completion of card-based activities, but may also be awarded for other activities, such as sharing a CDP profile with others or inviting new users. Card may be delivered to users based on information provided by recommendation engine 204b. According to some embodiments, premium cards may be offered and available for “purchase” with points gained through completion of challenges, milestones, etc. Further, with points, users may be able to buy other items such as products and services.

### Architecture—Presentation Layer

With reference to FIG. 2, the presentation layer 206 may include one or one or more interfaces (e.g., game dashboard 206a, child development profile (CDP) 206b, and CDP timeline 206c) through which insights derived at the services layer 204 may be presented to users (e.g. users 102a-102n).

According to some embodiments, users 102a-102n may access information and interact with the system via a mobile computing device, for example a device 104a-104n. As described earlier, interface may be facilitated via a locally installed client software capable of connecting to Platform 106 and remote services 108a-108n, or interface may be possible via a web portal without the need for specialized client software.

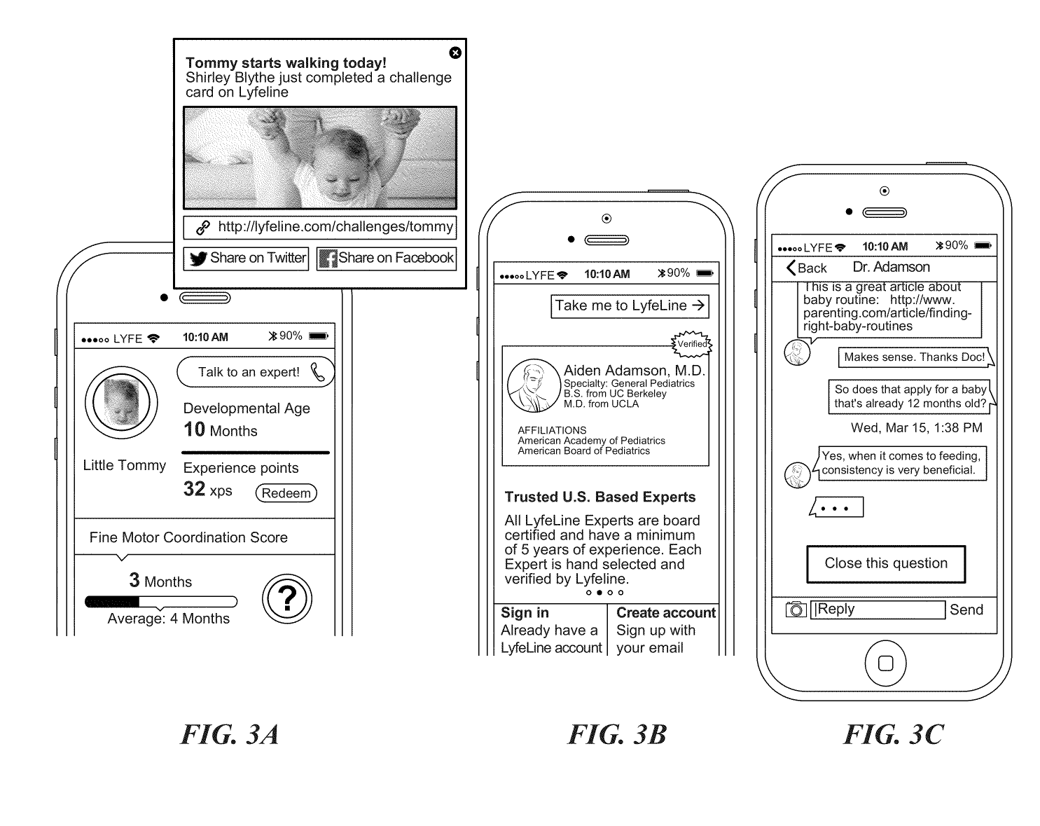

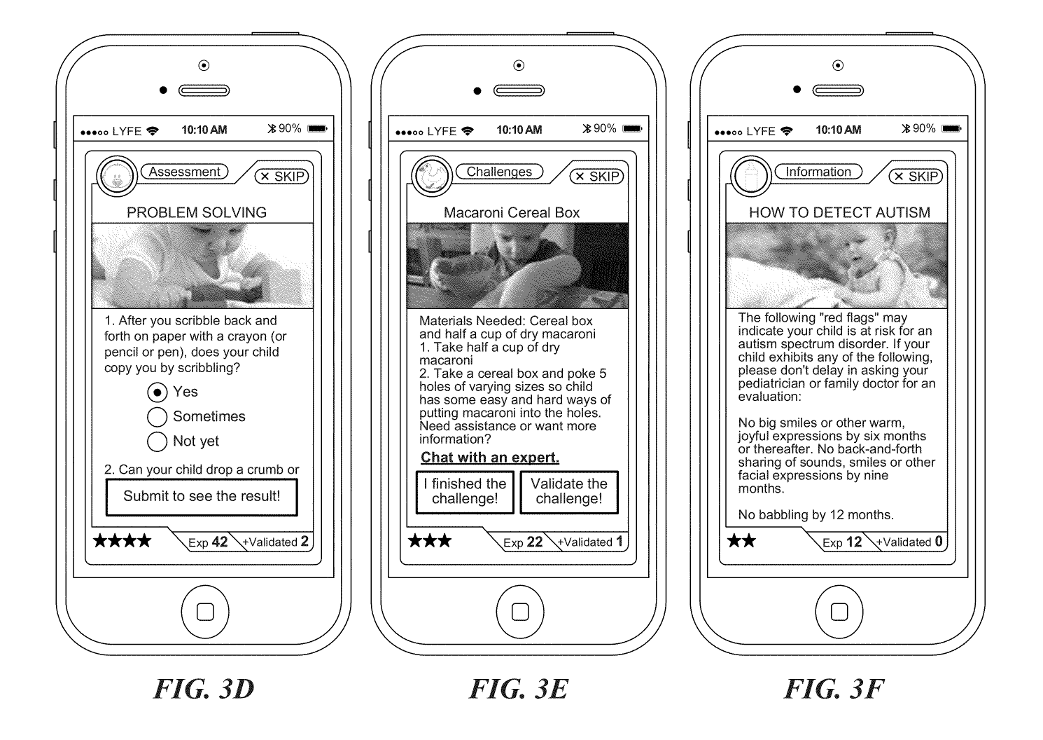

FIGS. 3A-3F illustrate example presentation layer interfaces accessible via a device, according to some embodiments.

As illustrated in FIG. 3A, a Child Development Profile (“CDP”) may be presented to users at the presentation layer as a dashboard. In this example, information is provided to parents that shows their child's developmental progress. According to some embodiments, information presented in the CDP may be derived via the game engine 204c based on the child's progress through the “core loop” game (discussed in more detail below). Information available may include, but is not limited to: (i) the child's current level or “developmental age” (generally and in specific topics, e.g. fine motor coordination), (ii) total experience points awarded during the “game,” (iii) activities and points rewarded, (iv) cards available or unlocked, (iv) premium cars that may be purchased with experience points, (v) the child's assessment scores, (vi) information relating the child's scores and achievements to the children of other users utilizing Platform 106, and (vii) an avatar or photograph of the main character in the “game” (i.e., the child). Further, various interactive features may be presented to users via the interface. For example, as shown in FIG. 3A, a button may be presented allowing parents to contact (e.g., via phone, video chat, or text chat) an expert to discuss their child's progress. Additionally, options may be presented to share information captured in the child's CDP with other users, as well as non-user friends, family members, etc. According to some embodiments, a full CDP may be associated with several users. For example, parents may wish to allow their child's grandparents to periodically check in on the child's progress, by simply accessing the CDP dashboard interface via their own device or via a web interface on personal computer. Alternatively, parents may share specific achievements with other users or non-user friends and family members. For example, as shown in FIG. 3A, parents may share the completion of a challenge card with others. In this illustrative example, a parent has share the fact that their child, Tommy, has completed a challenge card and has taken his first steps. According to some embodiments, shared information may, for example, include images and/or video of Tommy's first steps captured and uploaded via a device 104a-104n. According to some embodiments, achievements may be shared with other users 102a-102n of Platform 106, and/or may be shared with others connected to users 102a-102n via third party social network services. As shown in FIG. 3A, the parent may share Tommy's achievement with their friends via Facebook® or Twitter®.

According to some embodiments, the CDP dashboard interface may configured to show different informational insights depending on the intended viewer. For example, the dashboard interface shown in FIG. 3A may be intended for parents, friends and family members. Alternatively, the CDP dashboard may be configuration to include information intended for experts. For example, a CDP dashboard may include automatically derived red flags based on parent responses to assessment questions and/or delays in milestone achievements. Using this information, an expert may better be equipped to work with the parents and children and suggest remedies.

Although not shown in FIGS. 3A-3F, a CDP dashboard may include a journal or timeline. For example, for every child development topic, a CDP timeline may show the child's progress in various areas (e.g. development age or challenge cards completed) across a particular time interval. For example, according to some embodiments, the timeline may be presented in the form of a graph or chart showing an increase in the child's developmental age over time. Such a chart may track specific milestones completed as well as annotations associated with those milestones. According to some embodiments, annotations may include images, video, and or audio captured via a device 104a-104n at the time that the child me the milestone. For example, consider a timeline that charts the child's progress in developmental age in the gross motor category. A particular data point representing a milestone on the timeline may be selected by a user 102a-102n, for example via a touch interface. In response to the user's selection a video may begin to play showing that child's reaching the milestone, for example taking their first steps and walking.

According to some embodiments, images/video/audio may be captured separately by users and incorporated or associated with a milestone manually, or, according to some embodiments, images/video/audio may be captured as part of the validation process for various challenges and assessment milestones. For example, a challenge card may require validation by an expert in order to complete the challenge. The validation process may require the user to upload video of their child completing the challenge to send to an expert. This uploaded video may then be linked to a milestone date on the journal timeline.

As illustrated in FIGS. 3B and 3C, a communication interface may be presented to users at the presentation layer allowing them to communicate with experts. In example FIG. 3B, information about an expert is provided to a user 102a-102n. Information presented may include, but is not limited to: (i) name/contact info, (ii) affiliations, (iii) qualifications, and (iv) user reviews. With this information, users may contact experts to discuss their child's development. For example, FIG. 3C shows a text chat interface in which parent may parent may communicate with an expert. FIG. 3C is show for illustrative purposes, however it shall be understood that communication with experts may take a number of forms including video chat, phone calls, email, etc. Further, while communication services may be provided by Platform 106, they may also be provided by a third-party remote service 108n, for example a third-party chat service integrated into client software via an application programming interface (API).

As illustrated in FIGS. 3D-3F, elements of the “core loop” game may be presented to users at the presentation layer. FIG. 3D illustrates an example assessment card as it may be presented via a device 104a-104n of a user 102a-102n. FIG. 3E illustrates an example challenge card as it may be presented via a device 104a-104n of a user 102a-102n. FIG. 3F illustrates an example information card as it may be presented via a device 104a-104n of a user 102a-102n. Additional information regarding the “core loop” and assessment/challenge/information cards is provided herein under the section, titled “The ‘Core Loop’ Gamification Model.”

FIGS. 3A-3F are provided to illustrate example interface elements at the presentation layer according to some embodiments, but are not intended to be limiting.

### The “Core Loop” Model

The “core loop” describes a gamification model for child development according to the disclosed teachings. The “core loop” gamification model may provide a unique combination of services to support an iterative cycle of activities including child development screening, learning, expert consultation and challenge-based improvement. Activities may be deigned to be part of a game experience that rewards users 102a-102n (and in turn their children) for successful completions and demonstrated improvement.

Prior to entering the core loop, a system 100 according to the present teachings may gather information to better tailor the game mechanics to a particular user. According to embodiments, a system 100 may prompt a user for certain basic information regarding themselves and their child, for example, name, sex, date of birth, etc. According to some embodiments a system 100 may prompt a user to perform an initial assessment. As discussed earlier, an initial assessment may be in the form of a questionnaire answered by parents about their children, for example the ASQ-3™. An assessment questionnaire may serve as an underlying basis for classifying a child's developmental age and includes questions broken up into five main topics, (i) gross motor coordination, (ii) fine motor coordination, (iii) personal-social, (iv) communication, and (v) problem solving. An assessment questionnaire may be generally administered at the following age intervals (by month): 2, 4, 6, 8, 9, 10, 12, 14, 16, 18, 20, 22, 24, 27, 30, 33, 36, 42, 48, 54, and 60. Accordingly different questions may be presented at the initial assessment depending on the age of the child when the parents begin the game. Ideally parents would begin the game at the earliest age interval, 2 months in order to gain the full benefits of the child development program. After the parents have answered the initial assessment questionnaire, a system 100 may process the answers and provide the parents with initial results. Initial results may be provided via an interface at a device 104a-104n as previously described (see e.g, FIG. 3A). For example, an initial result may include distilled information such as developmental age (as opposed to the child's actual age), a comparison of how the child's developmental age compares to other children, and suggestions on key areas to work on.

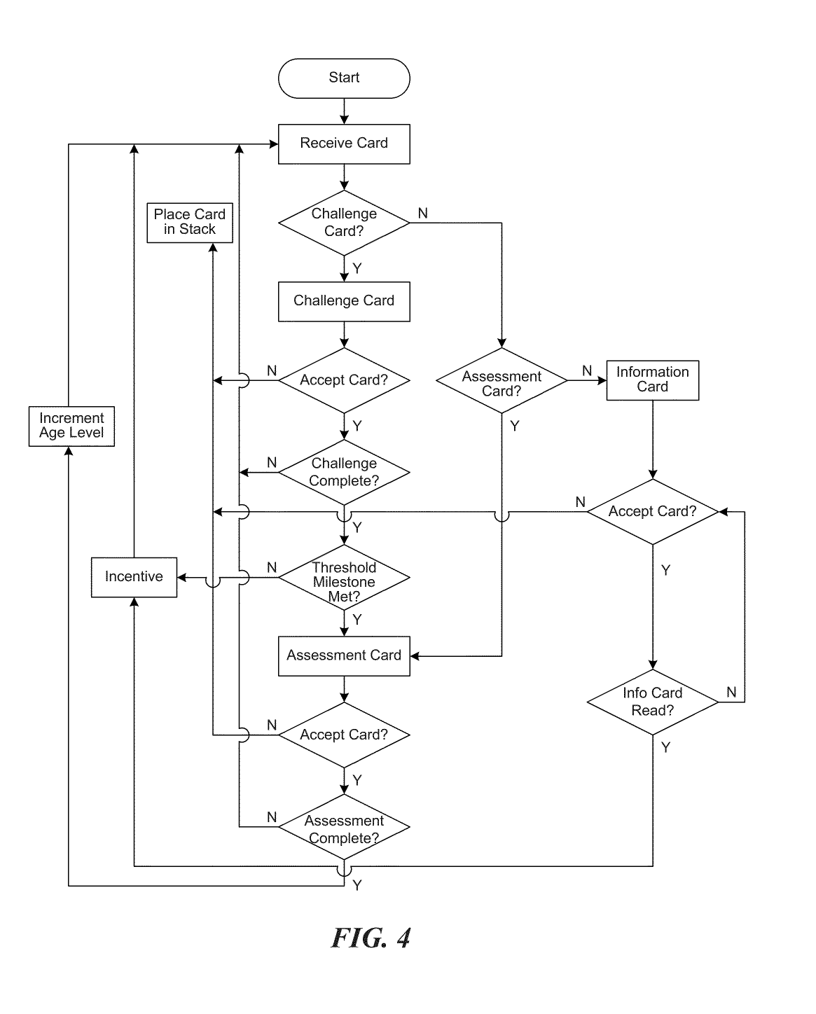

Once the initial assessment is completed the “game” enters the “core loop.” The “core loop” may be organized as follows. Step one, a user 102a-102n (i.e. parent) receives one of three types of cards via their device 104a-104n, (i) information cards, (ii) challenge cards, and (iii). Additional details on the cards are provided below. Cards may be received at random by the user 102a-102n in the sense that they may be received at random intervals. Receiving the cards at random intervals may build anticipation on the part of the user 102a-102n as since they will be surprised when they receive a card. The types of card received may be random, however according to some embodiments, the cards may be selected based on information provided (e.g. via the initial assessment or prior recorded activities) in order to more effectively promote the development of the child. As previously described, a recommendation engine 204b may select relevant cards based on ontology-based semantic matchmaking algorithms. At step two, users 102a-102n may have the option of accepting the card (i.e. reading it, taking the challenge, or performing an assessment). Cards that are not accepted may start to pile up and users 102a-102n may be required to clear their stack periodically. According to some embodiments, cards may include an associated expiration date of which users 102a-102n may be notified as the date approaches. At step three, having accepted a card, users may perform the task associated with the card. By completing tasks, users 102a-102n may be awarded incentives such as points, rewards, premium content, new more challenging cards, etc. According to some embodiments, receiving and completing more assessment cards may increment the child's developmental age. FIG. 4 shows a high-level flow chart illustrating an example “core-loop” process, according to some embodiments. This flow chart is illustrative of one embodiment for implementing a “core loop” gamification model. Other gamification models may include more, fewer, or different steps.

According to some embodiments, challenge cards may provide users 102a-102n (i.e parents) with an exercise to do with their child to further the child's development. Challenge cards may include one or more of the following characteristics, (i) difficulty ranking, (ii) time limitation, (iii) validation by an expert, (iv) activity specification, and (v) developmental topic. As previously discussed challenges may be tailored to development in certain areas. For example, recall the “catch the roller” challenge card intended to progress development in the fine motor coordination topic. Successfully preforming challenges may result in one or more of the following incentives: (i) points awarded for achievement (points awarded may depend on difficulty level, time limitations, and whether the achievement was validated by an expert, i.e. points may be assessed differently), (ii) progress towards achieving an assessment card, (iii) trophies, badges, and other awards, (iv) access to premium content, (v) unlocking of more advanced challenge cards, and (vi) options to share the achievement (e.g., via Facebook® or Twitter®). As mentioned, challenges associated with challenge cards may be associated with important child development milestones. According to some embodiments, after a parent along with their child have successfully completed a threshold number of challenges in a particular child development area they may receive an assessment card related to that area. According to some embodiments, challenge cards may be received and viewed by users 102a-102n via a device 104a-104n as illustrated in FIG. 3E. As shown in FIG. 3E, a challenge card may include the activity specification, i.e. instructions on completing the challenge as well as information about the developmental area it pertains to, difficulty level, experience points to be awarded upon successful completion. Instructions on completing the challenge may be provided via text, or may include diagrams, pictures, video, and/or audio. Challenge cards may also include interactive elements, such as buttons to seek validation of the challenges, options to contact an expert, and/or options to capture images/video/audio of one's child completing the challenge and then to share that with others (e.g. via a third-party social network service 108b).

The following are some example challenges that may be associated with challenge cards:

Example Challenge: “Signs”
Topic: Communication
Goal: Increase language and communication skills and cognitive development.
Materials: None
Age level: 0-9 months
Possible experience points: 25
Instructions: (1) learn the sign for “more,” (2) show the child the sign for “more” during an activity such as feeding when you want to know whether your child wants more of something, and (3) use sign for “more” until your child begins to sign back at you—consistency is key
Success criteria: Child is able to use the sign for “more” when he/she signs back at you.
Bonus: Learn other signs and teach them to your child using the same method

Example Challenge: “Find the Toy”
Topic: Problem Solving
Goal: Increase cognitive development and social awareness.
Materials: A small toy and several cloths
Age level: 8-18 months
Possible experience points: 15
Instructions: (1) get your child interested in the toy, (2) cover the toy completely with the cloth, (3) encourage the child to find the toy, for example say, “Where did it go?!,” (4) If the child does not respond, uncover the toy partially and ask again, “Where did it go?!,” (5) If the child still does not attempt to identify the toy, point to it and exclaim, “Here it is!,” and (6) repeat until child is able to find the toy on his or her own with the cloth fully covering it.
Success criteria: Child is able to find the toy on his or her own with the cloth fully covering it.

Example Challenge: “Dump and Fill”
Topic: Fine Motor Coordination
Goal: Improve child's fine and gross motor coordination.
Materials: Pan, rice, oatmeal, beans, 2 plastic measuring cups, measuring spoons
Age level: 16-36 months
Possible experience points: 35
Instructions: (1) place two inches of rice, oatmeal, and beans in a pan, (2) have the child fill a measuring cup using a measuring spoon, (3) have the child pour rice, oatmeal, and beans form one measuring cup into another without spilling, (4) have the child pour full measuring cup back into pan, (5) have child fill measuring cup using his or her hands, (6) have child pour rice, oatmeal, and beans from one measuring cup into another without spilling.
Success criteria: Child is able to fill the measuring cup and pour the contents of the cup into another cup without spilling.

According to some embodiments, assessment cards may be provided to users 102a-102n to assess whether their child is progressing in in their development. Successful completion of an assessment card may result in incrementing the child's developmental age. Assessment cards may be pushed to users 102a-102n at random, or may be pushed via a recommendation engine 204b according to certain met criteria. For example, users 102a-102n may receive assessment cards after they have successfully completed a threshold number of challenge cards indicating their child's development in a particular area. Users 102a-102n may also receive assessment cards when their child reaches a certain actual age, for example at the monthly intervals related to an assessment questionnaire such as the ASQ-3™. Generally, assessment cards may include one or more questions, for example questions similar to the questions that appear in an assessment questionnaire such as the ASQ-3™, however assessment cards may also include specific challenges as well as any combination thereof. Successfully completing assessment cards may result in one or more of the following incentives: (i) points awarded for achievement, (ii) badges, trophies or other awards (e.g., indicating that a child is in the top 10% of their age group), and (iii) incrementing to a next level or child development age. According to some embodiments, assessment cards may be received and viewed by users 102a-102n via a device 104a-104n as illustrated in FIG. 3D. As shown in FIG. 3D, assessment cards may include one or more assessment questions as well as information about the developmental area it pertains to, difficulty level, and experience points to be awarded upon successful completion.

According to some embodiments, information cards may be provided to users 102a-102n to help them learn about their developing child. Information cards may generally relate to a specific topic (e.g. one of the five topics identified in the ASQ-3™). The information presented in information cards may be text-based or contain multimedia such as picture, video and audio. While intended to provide useful information to parents, information cards may include information in a distilled easier to understand format that does not require too much of a time commitment in order to digest. In this way, information cards may encourage parents to both learn, but also may encourage them to pose questions to experts (e.g. via the communications interface previously discussed). For example, an information card about autism may provide parents with basic information regarding risk factors and indicators, but would encourage the parents to seek out more detailed specific information from experts regarding how to care for and develop a child that may exhibit symptoms of autism. According to some embodiments, information cards may be provided to users 102a-102n at random, or they may be provided based on available information (e.g. via recommendation ending 204b). For example, through the course of performing various challenges and assessments, a system in accordance with the present teachings may identify that a particular child is progressing steadily in certain areas (e.g. gross and fine motor coordination), but lagging in others (e.g. personal-social and communication). Certain patterns of development may raise indicators of certain conditions. For example, in this case, the system may recognize a pattern suggesting autism and therefore push an information card related to autism in order to inform the parent and encourage them to seek expert advice. According to some embodiments, information cards may include interactive elements such as quizzes to help users better digest and retain the information provided. According to some embodiments, information cards may be received and viewed by users 102a-102n via a device 104a-104n as illustrated in FIG. 3F.

### Monetization

The present teachings may be monetized in a number of ways.

According to some embodiments, access to features may require users to sign up for paid subscriptions. In some cases subscriptions may be tiered, for example offering basic functionality such a limited initial assessment and limited available cards for a low monthly rate or for free and offering additional functionality at varying subscription tiers up to a full subscription.

According to some embodiments premium content may be made available for purchase. For example, premium cards such as more challenging challenge cards not otherwise available via regular subscription may be purchased using regular currency or using experience points gained through playing the game.

According to some embodiments, user purchases of recommend products or services may be monetized. Similar to double-click advertising, a recommendation engine 204b may push advertisements for recommended products based on the interests of users 102a-102n as well as the measured needs of their children. For example, a recommendation engine 204b may derive a recommendation for a particular puzzle toy based on a user's interest in problem-solving challenges as well as their child's measured lagging in the problem-solving skills. An advertisement may be provided to the user for the puzzle toy, for example via a third-party e-commerce service 108a, and based on whether the user clicks or otherwise views or selects the advertisement, a provider of Platform 106 may receive a fixed fee or percentage of sale from either the toy manufacturer or a vendor associated with e-commerce service 108a.

According to some embodiments, fees may be gathered based on interactions with experts. For example, parents may pay experts a fixed fee or a time-based rate for their consultation services via Platform 106. Accordingly a provider of Platform 106 may collect a percentage or fixed amount based on those fees collected by experts. Alternatively, experts may pay a fee to a provider of Platform 106 to be listed as an available for consultation.

The above provided examples are intended to be illustrative of various ways a system in accordance with the present teachings may be monetized. They should in no way be read as limiting, for example a system in accordance with the present teachings may include one or more of the described monetization schemes as well as others not described, or may be offered for free without any monetization goal.

### Background on Cloud-Based Server

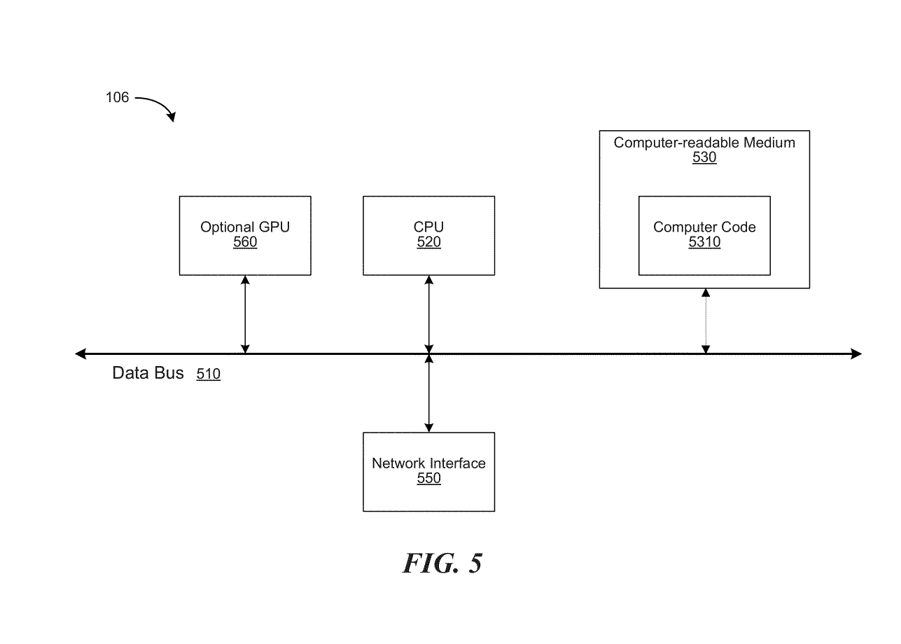

FIG. 5 illustrates a schematic block diagram of an example cloud-based server of a Child Development Computing Platform (Platform) 106 according to some embodiments of the present disclosure. The server may include at least one processor 520, one or more optional GPU 560, one or more network interface 550 and one or more computer readable medium 530, all interconnected via one or more data bus 510. In FIG. 5, various components are omitted for illustrative simplicity. FIG. 5 is intended to illustrate a device on which any suitable components described in this specification (e.g., any suitable components depicted in FIGS. 1-4) can be implemented.

The cloud-based server of Platform 106 may take a variety of physical forms. By way of examples, the server may be a desktop computer, a laptop computer, a personal digital assistant (PDA), a portable computer, a tablet PC, a wearable computer, an interactive kiosk, a mobile phone, a server, a mainframe computer, a mesh-connected computer, a single-board computer (SBC) (e.g., a BeagleBoard, a PC-on-a-stick, a Cubieboard, a CuBox, a Gooseberry, a Hawkboard, a Mbed, a OmapZoom, a Origenboard, a Pandaboard, a Pandora, a Rascal, a Raspberry Pi, a SheevaPlug, a Trim-Slice), an embedded computer system, or a combination of two or more of these. Where appropriate, Platform 106 may include one or more servers, be unitary or distributed, span multiple locations, span multiple machines, or reside in a cloud, which may include one or more cloud components in one or more networks. Where appropriate, cloud-based servers of Platform 106 may perform without substantial spatial or temporal limitation one or more steps of one or more methods described or illustrated herein. As an example and not by way of limitation, cloud-based servers of a Platform 106 may perform in real time or in batch mode one or more steps of one or more methods described or illustrated herein. Cloud-based servers of a Platform 106 may perform at different times or at different locations one or more steps of one or more methods described or illustrated herein, where appropriate.

A cloud-based server of Platform 106 may preferably include an operating system such as, but not limited to, Windows®, Linux® or UNIX®. The operating system may include a file management system, which organizes and keeps track of files. In some embodiments, a separate file management system may be provided. The separate file management can interact smoothly with the operating system and provide enhanced and/or more features, such as improved backup procedures and/or stricter file protection.

The at least one processor 520 may be any suitable processor. The type of the at least one processor 520 may comprise one or more from a group comprising a central processing unit (CPU), a microprocessor, a graphics processing unit (GPU), a physics processing unit (PPU), a digital signal processor, a network processor, a front end processor, a data processor, a word processor and an audio processor.

The one or more data bus 510 is configured to couple components of the cloud-based server to each other. As an example and not by way of limitation, the one or more data bus XXX may include a graphics bus (e.g., an Accelerated Graphics Port (AGP)), an Enhanced Industry Standard Architecture (EISA) bus, a front-side bus (FSB), a HyperTransport (HT) interconnect, an Industry Standard Architecture (ISA) bus, an Infiniband interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Although the present disclosure describes and illustrates a particular bus, this disclosure contemplates any suitable bus or interconnects.

The one or more network interface 550 may include one or more of a modem or network interface. It will be appreciated that a modem or network interface can be considered to be part of a cloud-based server of the Platform 106. The interface can include an analog modem, an asymmetric digital subscriber line (ADSL) modem, a cable modem, a doubleway satellite modem, a power line modem, a token ring interface, a Cambridge ring interface, a satellite transmission interface or any suitable interface for coupling a computer system to other computer systems. The interface can include one or more input and/or output devices. The I/O devices can include, by way of example but not limitation, a keyboard, a mouse or other pointing device, disk drives, printers, a scanner, a touch screen, a Tablet screen, and other input and/or output devices, including a display device. The display device can include, by way of example but not limitation, a cathode ray tube (CRT) display, a liquid crystal display (LCD), a 3-D display, or some other applicable known or convenient display device. For simplicity, it is assumed that controllers of any devices not depicted in the example of FIG. 5 reside in the interface.

The computer readable medium 530 may include any medium device that is accessible by the processor 520. As an example and not by way of limitation, the computer readable medium 530 may include volatile memory (e.g., a random access memory (RAM), a dynamic RAM (DRAM), and/or a static RAM (SRAM)) and non-volatile memory (i.e., a flash memory, a read-only memory (ROM), a programmable ROM (PROM), an erasable programmable ROM (EPROM), and/or an electrically erasable programmable ROM (EEPROM)). When appropriate, the volatile memory and/or non-volatile memory may be single-ported or multiple-ported memory. This disclosure contemplates any suitable memory. In some embodiments, the computer readable medium 530 may include a semiconductor-based or other integrated circuit (IC) (e.g., a field-programmable gate array (FPGA) or an application-specific IC (ASIC)), a hard disk, an HDD, a hybrid hard drive (HHD), an optical disc (i.e., a CD-ROM, or a digital versatile disk (DVD)), an optical disc drive (ODD), a magneto-optical disc, a magneto-optical drive, a floppy disk, a floppy disk drive (FDD), a magnetic tape, a holographic storage medium, a solid-state drive (SSD), a secure digital (SD) card, a SD drive, or another suitable computer-readable storage medium or a combination of two or more of these, where appropriate. The computer readable medium 530 may be volatile, non-volatile, or a combination of volatile and non-volatile, where appropriate.

Computer code 5310 may be stored on the one or more computer readable medium 530. As an example, but not by way of limitation, a cloud-based server of Platform 106 may load the computer code 5310 to an appropriate location on the one or more compute readable medium 5310 for execution. The computer code 5310, when executed, may cause the cloud-based server to perform one or more operations or one or more methods described or illustrated herein. According to some embodiments, the operations may include the transmitting and receiving of data, the processing of data by one or more engines operating at the service layer 204 (e.g. data analytics engine 204a, recommendation engine 204b, and game engine 204c), and the rendering of graphical interface elements at the presentation layer 206.

As will be appreciated by one of ordinary skill in the art, the operations may be instantiated locally (i.e. on single physical server) and may be distributed across a system of available computing devices including devices 104a-104n. For example, it may be determined that certain operations may be performed locally at a device 104a-104n and may be offloaded to the cloud-based servers of Platform 106 when the processing limitations of devices 104a-104n are met.

### Background on Computing Devices

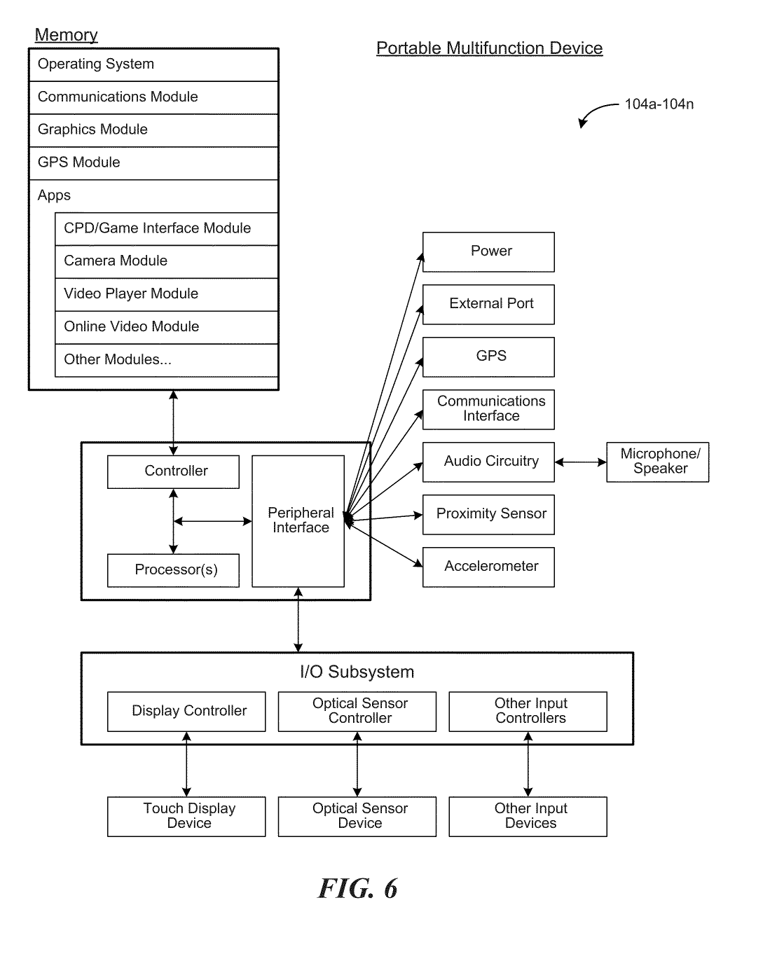

FIG. 6 is a block diagram illustrating an example computing device (“device”) 104a-104n in accordance with some embodiments. The device 104a-104n may include a memory (which may include one or more computer readable storage mediums), a memory controller, one or more processing units which may include central processing units (CPUs) and graphics processing units (GPUs), a peripherals interface, network communications interface, audio interface, a speaker, a microphone, an input/output (I/O) subsystem, other input or control devices, and an external port. The device 104a-104n may include one or more optical sensors. These components may communicate over one or more communication buses or signal lines.

It should be appreciated that the device 104a-104n is only one example of a computing device, and that the device 104a-104n may have more or fewer components than shown, may combine two or more components, or a may have a different configuration or arrangement of the components. The various components shown in FIG. 6 may be implemented in hardware, software or a combination of both hardware and software, including one or more signal processing and/or application specific integrated circuits.

Memory may include high-speed random access memory and may also include non-volatile memory, such as one or more magnetic disk storage devices, flash memory devices, or other non-volatile solid-state memory devices. Access to memory by other components of device 104a-104n, such as the processor(s) and the peripherals interface, may be controlled by the memory controller.

The peripherals interface couples the input and output peripherals of the device to the CPU and memory. One or more processors may run or execute various software programs and/or sets of instructions stored in memory to perform various functions for the device 104a-104n and to process data.

In some embodiments, the peripherals interface, the processor(s), and the memory controller may be implemented on a single chip, such as a chip. In some other embodiments, they may be implemented on separate chips.

The network communications interface may facilitate transmission and reception of communications signals often in the form of electromagnetic signals. The transmission and reception of electromagnetic communications signals may be carried out over physical media such copper wire cabling or fiber optic cabling, or may be carried out wirelessly for example, via a radiofrequency (RF) transceiver. In some embodiments the network communications interface may include RF circuitry. In such embodiments RF circuitry may convert electrical signals to/from electromagnetic signals and communicate with communications networks and other communications devices via the electromagnetic signals. The RF circuitry may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, or any other suitable communication protocol, including communication protocols not yet developed as of the filing date of this document.

The audio circuitry, the speaker, and the microphone may provide an audio interface between a user 102a-102n and the device 104a-104n. The audio circuitry may receive audio data from the peripherals interface, converts the audio data to an electrical signal, and transmits the electrical signal to the speaker. The speaker may convert the electrical signal to human-audible sound waves. The audio circuitry may also receive electrical signals converted by the microphone from sound waves. The audio circuitry converts the electrical signal to audio data and transmits the audio data to the peripherals interface for processing. Audio data may be retrieved from and/or transmitted to memory and/or the network communications interface by the peripherals interface.

The I/O subsystem couples input/output peripherals on the device 104a-104n, such as a touch sensitive display system and other input/control devices, to the peripherals interface. The I/O subsystem may include a display controller and one or more input controllers for other input or control devices. The one or more input controllers receive/send electrical signals from/to other input or control devices. The other input/control devices may include physical buttons (e.g., push buttons, rocker buttons, etc.), dials, slider switches, joysticks, click wheels, and so forth. The touch screen is used to implement virtual or soft buttons and one or more soft keyboards.

The touch-sensitive touch screen provides an input interface and an output interface between the device and a user. The display controller receives and/or sends electrical signals from/to the touch screen. The touch screen displays visual output to the user. The visual output may include graphics, text, icons, video, and any combination thereof (collectively termed “graphics”). In some embodiments, some or all of the visual output may correspond to user-interface objects, further details of which are described below.

A touch sensitive display system may have a touch-sensitive surface, sensor or set of sensors that accepts input from the user based on haptic and/or tactile contact. The touch sensitive display system and the display controller (along with any associated modules and/or sets of instructions in memory) detect contact (and any movement or breaking of the contact) on the touch screen and converts the detected contact into interaction with user-interface objects (e.g., one or more soft keys, icons, web pages or images) that are displayed on the touch screen. In an exemplary embodiment, a point of contact between a touch screen and the user corresponds to a finger of the user.

The touch screen may use LCD (liquid crystal display) technology, or LPD (light emitting polymer display) technology, although other display technologies may be used in other embodiments. The touch screen and the display controller may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen.

The device 104a-104n may also include a power system for powering the various components. The power system may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The PMD may also include one or more optical sensors. FIG. 6 shows an optical sensor coupled to an optical sensor controller in I/O subsystem. The optical sensor may include charge-coupled device (CCD) or complementary metal-oxide semiconductor (CMOS) phototransistors. The optical sensor receives light from the environment, projected through one or more lens, and converts the light to data representing an image. In conjunction with an imaging module (also called a camera module), the optical sensor may capture still images or video. In some embodiments, an optical sensor is located on the back of the device 104a-104n, opposite the touch screen display on the front of the device, so that the touch screen display may be used as a viewfinder for either still and/or video image acquisition. In some embodiments, an optical sensor is located on the front of the device so that the user's image may be obtained for videoconferencing while the user views the other video conference participants on the touch screen display. In some embodiments, the position of the optical sensor can be changed by the user (e.g., by rotating the lens and the sensor in the device housing) so that a single optical sensor may be used along with the touch screen display for both video conferencing and still and/or video image acquisition.

The device 104a-104n may also include one or more proximity sensors. FIG. 6 shows a proximity sensor coupled to the peripherals interface. Alternately, the proximity sensor may be coupled to an input controller in the I/O subsystem.

The device 104a-104n may also include one or more accelerometers. FIG. 6 shows an accelerometer coupled to the peripherals interface. Alternately, the accelerometer may be coupled to an input controller in the I/O subsystem.

The device 104a-104n may also include a global positioning system (GPS) receiver. FIG. 6 shows a GPS receiver coupled to the peripherals interface. Alternately, the GPS receiver may be coupled to an input controller in the I/O subsystem. The GPS receiver may receive signals from GPS satellites in orbit around the earth, calculate a distance to each of the GPS satellites (through the use of GPS software, e.g GPS module), and thereby pinpoint a current global position of a device 104a-104n. In some embodiments, global positioning of the device 104a-104n may be accomplished without GPS satellites through the use of similar techniques applied to cellular and/or Wi-Fi signals received from cellular and/or Wi-Fi antennae.

In some embodiments, the software components stored in memory may include an operating system, a communication module (or set of instructions), a contact/motion module (or set of instructions), a graphics module (or set of instructions), a text input module (or set of instructions), a Global Positioning System (GPS) module (or set of instructions), and applications (or set of instructions).

The operating system (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module facilitates communication with other devices over one or more external ports and also includes various software components for handling data received by the network communications interface and/or the external port. The external port (e.g., Universal Serial Bus (USB), FIREWIRE, etc.) is adapted for coupling directly to other devices or indirectly over a network (e.g., the Internet, wireless LAN, etc.).

The contact/motion module may detect contact with the touch screen (in conjunction with the display controller) and other touch sensitive devices (e.g., a touchpad or physical click wheel). The contact/motion module includes various software components for performing various operations related to detection of contact, such as determining if contact has occurred, determining if there is movement of the contact and tracking the movement across the touch screen, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, the contact/motion module and the display controller also detect contact on a touchpad.

The graphics module includes various known software components for rendering and displaying graphics on the touch screen, including components for changing the intensity of graphics that are displayed. As used herein, the term “graphics” includes any object that can be displayed to a user, which may include, but not be limited by, text, web pages, icons (such as user-interface objects including soft keys), digital images, videos, animations and the like.

The text input module, which may be a component of the graphics module, provides soft keyboards for entering text in various applications (e.g., contacts, e-mail, IM, blogging, browser, and any other application that needs text input).

The GPS module may determine the location of the device and provides this information for use in various applications (e.g., to the camera as picture/video metadata, and to applications that provide location-based services).

The applications may include one or more modules (or sets of instructions), or a subset or superset thereof, for example the applications may include a

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, memory may store a subset of the modules and data structures identified above. Furthermore, memory may store additional modules and data structures not described above.

In some embodiments, the device 104a-104n is a device where operation of a predefined set of functions on the device is performed exclusively through a touch screen and/or a touchpad.

### REMARKS AND DISCLAIMERS

The disclosed description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

What is claimed is:

1. A computer-implemented method for facilitating child development, the method comprising the steps of:
automatically selecting, by one or more processors, a computer-generated card from a set of computer-generated cards, wherein each of the computer-generated cards in the set fall under one of at least three card varieties;
presenting, via a network-connected device, the selected computer-generated card, the selected computer-generated card including an option to provide a response to the selected computer-generated card;
receiving, via a network, the response to the selected computer-generated card;
assessing, by one or more processors, the response for indicators of progress in at least one of a plurality of child development categories, wherein each of the plurality of child development categories is associated with one or more predefined threshold milestones; and
incrementing, by one or more processors, a child development age value if a threshold milestone is reached in at least one of the child development categories.

2. The method of claim 1, wherein the plurality of child development categories include: cross motor coordination, fine motor coordination, interpersonal skills, communication, and problem solving.

3. The method of claim 1, wherein the at least three card categories include assessment cards, challenge cards, and information cards.

4. The method of claim 3, wherein assessment cards include one or more questions associated with the developmental progress of a particular child in one or more child development categories, wherein the options to provide a response include an option to submit answers to the one or more questions.

5. The method of claim 3, wherein challenge cards include a prompt to a user to perform one or more challenges with a particular child, the one or more challenges configured to promote child development in one or more child development categories, wherein the options to provide a response include an option to confirm that the one or more challenges have been completed.

6. The method of claim 5, wherein the one or more challenges include characteristics including one or more of, difficulty rank, time limitation, and expert assessment requirements.

7. The method of claim 5, wherein the options to provide a response include an option to upload a video of the user and the particular child completing the challenge.

8. The method of claim 3, wherein information cards include information associated with one or more child development categories, wherein the options to provide a response include an option to confirm that a user has received the information presented via the information card.

9. The method of claim 8, wherein the information associated with the information card is presented, via the network-connected device, as one or more of text, images, audio, and video.

10. The method of claim 1, wherein the automatic selecting of the computer-generated card is based on ontology-based semantic matchmaking algorithms.

11. The method of claim 1, further comprising:
receiving, via the network, initial information associated with a particular child prior to automatically selecting the computer-generated child; and
determining, by one or more processors, the child development age value associated with the particular child.

12. The method of claim 11, wherein the automatically selecting of the computer-generated card is based in part on the initial information and/or child development age value associated with the particular child.

13. The method of claim 11, further comprising:
presenting, via the network connected device, information associated with the particular child including the child development age value associated with the particular child.

14. The method of claim 1, wherein progress towards threshold milestones in the one or more child development categories is based in part on experience points awarded for received responses to computer generated cards, wherein the number of experience points awarded is based in part on a difficulty rating associated with the selected computer-generated card.

15. The method of claim 1, further comprising:
presenting, via the network connected device, a child development progress summary, the child development progress summary including threshold milestones reached and an indication of incremental progress of the child development age value.

16. The method of claim 1, wherein the network-connected device is one or more of a smart phone, smart watch, tablet computer, laptop computer, and desktop computer.

17. A system for facilitating child development, the system comprising:
one or more processors; and
one or more memory units having instructions stored thereon, which when executed by the one or more processors cause the system to:
automatically select a computer-generated card from a set of computer-generated cards, wherein each of the computer-generated cards in the set fall under one of at least three card varieties;
present, via a network-connected device, the selected computer-generated card, the selected computer-generated card including an option to provide a response to the selected computer-generated card;
receive, via a network, the response to the selected computer-generated card;
assess the response for indicators of progress in at least one of a plurality of child development categories, wherein each of the plurality of child development categories is associated with one or more predefined threshold milestones; and
increment, by one or more processors, a child development age value if a threshold milestone is reached in at least one of the child development categories.

18. The system of claim 17, wherein the one or more memory units have further instructions stored thereon, which when executed by the one or more processors, cause the system to further:
receive, via the network, initial information associated with a particular child prior to automatically selecting the computer-generated child; and
determine, by one or more processors, the child development age value associated with the particular child.

19. The system of claim 18, wherein the one or more memory units have further instructions stored thereon, which when executed by the one or more processors, cause the system to further:
present, via the network connected device, information associated with the particular child including the child development age value associated with the particular child.

20. The system of claim 17, wherein the one or more memory units have further instructions stored thereon, which when executed by the one or more processors, cause the system to further:
present, via the network connected device, a child development progress summary, the child development progress summary including threshold milestones reached and an indication of incremental progress of the child development age value.
